(19) United States
(12) Patent Application Publication
(10) Pub. No.: US 2010/0236574 A1
(43) Pub. Date: Sep. 23, 2010

(54) CLEANING SYSTEM AND METHOD FOR AIR-COOLED CONDENSER BUNDLES

(75) Inventor: Sanjeev Narayanan, Beijing (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Cooling Technologies, Inc., Overland Park, KS (US)

(21) Appl. No.: 12/408,471

(22) Filed: Mar. 20, 2009

(51) Int. Cl. B08B 7/04

(52) U.S. Cl. 134/10; 134/198

(57) ABSTRACT

A system and method for cleaning components of an air-cooled condenser has a spray cleaning system configured to spray cleaning fluid onto at least part of the air-cooled condenser; and a line that draws off condensate from the condenser that has been condensed by a condenser. The system feeds the drawn-off condensate to the cleaning system for use as the cleaning fluid.

### FIELD OF THE INVENTION

The invention pertains generally to the field of cooling towers, and more particularly to the field of air-cooled condenser towers. Some embodiments of the invention further pertain to methods and systems for cleaning components in such towers.

### BACKGROUND OF THE INVENTION

A wide variety of cooling towers are known in industry. One type of such cooling towers is an air-cooled condenser. An air-cooled condenser typically receives steam from a power plant and cools and condenses the steam so it can be returned to the power plant cycle. Typical power plants may include electrical generating facilities using steam turbines, or any other industrial type of plant that produces steam.

Some types of air-cooled condenser have a steam-receiving header which feeds a plurality of condenser tubes, which may be arranged in a parallel spaced arrangement, to form rectangular planar tube bundle panels. These cooling panels are in contact with ambient air, and have the air passing through them by virtue of a fan, or by natural draft convection. The steam in the tube panels is cooled and usually condensed to liquid form, and exits through exit headers at the other end of the panels, typically as warm water. This warm water, or condensate, is typically re-circulated back to a condensate tank, and then is returned by a condensate pump back to the power plant to go through the power plant cycle again. By going through the power plant cycle again, the condensate is turned to steam and is again fed to the air-cooled condenser to be condensed.

The tubes in a panel bundle may be relatively close together, and since they have ambient air passing over them during the condensing process, circumstances sometimes arise where the tubes become dirty. That is, dust or other particles entrained in the air may tend to adhere to or accumulate on the outsides of the tubes in the panel bundles. In some cases, this will reduce the heat transfer of the tubes in the panel bundles, adversely affecting performance of the system. Further, in some cases, if the adhering dirt is not removed, partial clogging of the air flow through the panels could occur.

### SUMMARY OF THE INVENTION

Some embodiments of the invention provide an improved system and method that can provide for cleaning of the outside of the tube panel bundles in order to remove accumulated dirt or particles.

In one aspect, some systems for cleaning components of an air-cooled condenser have a spray cleaning system configured to spray cleaning fluid onto at least part of the air-cooled condenser, and a line that draws off some condensate from the condenser that has been condensed by a condenser, and feeds the drawn-off condensate to the cleaning system for use as the cleaning fluid.

In another aspect, some systems include means for spraying cleaning fluid onto at least part of the air-cooled condenser and for diverting some of the condensate from the condenser that has been condensed by a condenser, and feeding the drawn-off condensate to the cleaning system for use as the cleaning fluid.

Other embodiments provide a power plant fluid handling system which contains a power plant that produces steam, an air-cooled condenser that receives the steam and provides a condensate, a condensate holding tank that holds the condensate from the condenser, a condensate pump that feeds condensate from the condensate holding tank back to the power plant, and a spray cleaning system mounted to spray cleaning fluid onto the air-cooled condenser. There is a line that draws off condensate that has been condensed by a condenser from the air-cooled condenser and feeds the drawn off condensate to the cleaning system for use as the cleaning fluid.

A further embodiment features means for generating steam in a power plant, means for cooling the steam into a condensate using a condenser, determining whether a cleaning cycle is to be performed, means for returning the condensate to the power plant when a cleaning cycle is not to be performed, and means for directing some condensate to be used as cooling water and supplying the cleaning water to a cleaning system, and returning the remainder of the condensate to the power plant, when a cleaning cycle is to be performed.

Another embodiment provides a method for cleaning an air-cooled condenser comprises generating steam in a power plant, cooling the steam into a condensate using a condenser, determining whether a cleaning cycle is to be performed, when a cleaning cycle is not to be performed, returning the condensate to the power plant, and when a cleaning cycle is to performed, drawing off some condensate to be used as cleaning fluid and supplying the cleaning fluid to a cleaning system, and returning the remainder of the condensate to the power plant.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram of a cleaning system utilized with an air-cooled condenser, according to one embodiment of the present invention.

FIG. 2 is a process step flow diagram of a method according to an embodiment of the invention.

### DETAILED DESCRIPTION

Some preferred embodiments provide an improved system and method that can provide for cleaning of the outside of the tube panel bundles in order to remove accumulated dirt or particles. Examples of some embodiments will now be described with reference to the drawing figures, in which like reference numbers refer to like parts throughout.

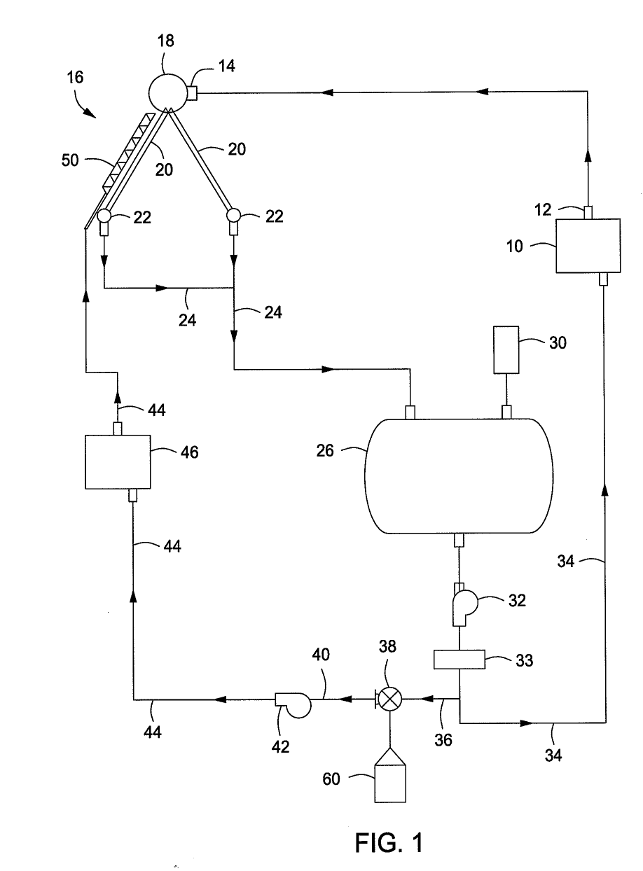

FIG. 1 schematically depicts a system, including some optional features, of an exemplary preferred embodiment of the present invention. A power plant 10 is schematically depicted. The power plant 10 may be any industrial facility or other facility that produces steam. Examples of industrial facilities comprising power plant 10 may include electrical generation power plants and other types of industrial or manufacturing facilities. Although not separately illustrated, the power plant 10 may include, for example, a boiler using a fuel to turn the water into steam, and a turbine which expands the steam in order to provide mechanical power. Such a turbine may drive generators in order to produce electricity. Nuclear power generating facilities are another example of power plants.

Regardless of the type of power plant 10 involved, the power plant 10 will have an outlet 12 which discharges steam. This steam is fed through a conduit system to supply an air-cooled condenser arrangement generally designated by 16. Any number of ducting arrangements may be employed to supply steam to various portions of the air-cooled condenser 16. One such arrangement is implementation of a manifold near grade with a series of riser ducts supplying parallel rows of fan unit modules called streets. Introduction of the steam into the air-cooled condenser 16 is represented schematically by port 14. More specifically, the steam can be fed into a header arrangement 18, which is shown as a single header tube 18 in this embodiment. Of course, in various known embodiments of air-cooled condensers 16, a number of headers 18 may be provided in parallel or other arrangement.

The steam that is provided to the header 18 passes downward through a pair of canted rows of tube panel bundles 20. The structure of each tube panel bundles 20 can be parallel tubes which are in contact with upwardly flowing ambient air so that the enclosed steam is cooled and condensed as it passes downwardly therethrough. In this example, the tube panel bundles 20 are canted and arranged in series longitudinally to form an “A” shape with respect to the upper header 18. A fan (not shown) may be provided above or below the tube panel bundles 20 as part of the overall air-cooled condenser structure 16, and may be surrounded by a fan shroud to control and direct the air flow through the tube panel bundles 20. The fan may be omitted and air flow may be caused by natural draft convection warming effects.

The steam will tend to cool and condense and the condensate can be removed via lower headers 22. The lower headers 22 collect essentially a warm liquid condensate which is removed via conduits 24 and deposited into a condensate tank 26. The condensate will typically accumulate in the condensate tank 26 at a relatively warm temperature which may be in some instances, for example, approximately 80-85° C. Preferably, in some instances, the water that is used in this cycle is so-called de-mineralized water. That is, the water used in this cycle is water that has been treated in order to remove minerals. De-mineralization treatments are well known.

A supply of de-mineralized water 30 is illustrated which maintains the level in the condensate tank 26 at a desired level. Such a supply 30 may be used for initial filling of the system, and also to provide make-up de-mineralized water in case some of the water is lost due to imperfections in the cycle. The condensate water is removed from the condensate tank 26 via a condensate pump 32. In one operating mode of the system, all of the condensate that is pumped out of the pump 32 will be provided to a conduit 34 which is a return conduit to the power plant 10.

In some embodiments of the invention, a take-off line 36 is provided (essentially for example as a T-fitting) off of the condensate line 34. A valve 38 is provided which can have one or more functions, providing other mode(s) of the system, including cleaning mode(s). The valve 38 can be operated manually or remotely or automatically or via a control program implemented by computer or otherwise. In one mode or function, if the valve 38 is closed, then the power plant and condensate cycle run in the first mode as has been described above. However, in another mode, as a cleaning function, if the valve 38 is opened, then some of the condensate from the condensate pump 32 will be directed, or drawn off, and travel through the conduit 36 and further into a conduit 40. At this stage, the drawn-off condensate (which may, by way of example, be at approximately 60-85° C. and 20-30 bar pressure) will be further pressurized by a cleaning system pump 42. The purpose of the take-off of a portion of the condensate pump water is to supply it to a cleaning arrangement as is further discussed.

After exiting the cleaning system pump 42, the take-off cleaning water can be at a higher pressure or temperature, and for example, can be over 100° C. and, for example, be at approximately at 60° C.-85° C. and 100-200 bar. This warm pressurized water, which has been tapped off of the condensate line 34 and has been pumped via the pump 42 can then be fed via a conduit 44 towards a cleaning system 50 disposed at or adjacent the air-cooled condenser 16.

The cleaning water could also be tapped from the outlet of one or more LP (Low Pressure) Heaters 33 where the condensate is heated with steam taken from the turbine. The low pressure heater(s) 33 refers to any number of heaters, for example, three heaters (H1), (H2) and/or (H3). The outlet of the first LP heater (H1) after the condensate pump is in the order of 80 to 105 deg C. This would eliminate the need for an optional additional heater as described in section [0024]. Depending on the need the cleaning water or condensate could also be tapped from the second (H2) or third (H3) LP Heaters where the outlet temperature of the condensate is in the range of 140 to 160 deg C. At this temperature the cleaning water is used as steam cleaning, as discussed further in paragraph 26.

In the illustrated embodiment, an optional supplemental heater 46 is shown in the line 44. The heater 46 can be utilized to further heat and/or pressurize the drawn-off condensate or cleaning water. In such case, the cleaning water can be heated to over 100° C., and for example to a temperature range of approximately 150-180° C.

Although the cleaning water is referred to as “water” in the specification, it will be appreciated that depending on the temperature and pressure of the cleaning water in the conduit 44, the cleaning water may actually exit the cleaning nozzles in the form of steam-water mixture, especially depending on the operation of a supplemental heater 46 or the cleaning water temperature depending on the take off point being after the LP-Heater 3.

The conduit 44 feeds the cleaning water into a cleaning system 50. In one embodiment the cleaning system 50 is essentially a support structure for a number of spray nozzles that will spray the cleaning fluid on to the exterior of the panel bundles 20. For simplicity, one cleaning system 50 is shown, on the left tube panel bundle only. However, it will be appreciated that in most instances the cleaning arrangement will be able to reach all of the tube panel bundles 20.

The cleaning system 50 can include rows of headers and spray nozzles so that the system 50 can spray over the entire system all at once. However, in order to reduce the fluid flow at a given time, as well as the structure required, the cleaning system 50 can be a row of spray nozzles which are mounted to a truss, with the truss mounted on track so that it can travel lengthwise along part of all of a row of tube panel bundles 20, thus covering all of the tube panel bundles 20 gradually during the travel. The types of nozzles and their spacing used in the cleaning system 50 is selected based on factors such as the expected temperature of the cleaning water, for example.

In another optional feature of the illustrated preferred embodiment, the valve 38 can also be connected to a supply 60 of readily available water in the area, such as municipal water, well water, river or lake water, or any other water supply. Thus, the cleaning water in the conduit 44 may be comprised of either: (a) entirely de-mineralized condensate from the condensate loop, (b) entirely the freely available water from the supply 60, or (c) some proportional combination of both. To the extent that the de-mineralized condensate water is used, this will provide heat so that the cleaning water will be warmer than the ambient temperature. Depending on this level of heat, and depending on whether freely available water 60 is used, it is optionally desirable to add further heat to the system via a supplemental heater 46. However, embodiments of the invention can be constructed, eliminating the supplemental heater 46, as well as the additional water source 60, and drawing warm water solely off of the condensate loop cleaning as desired.

In most instances, the amount of condensate fluid that is drawn off for cleaning is relatively small compared to the overall volumetric flow of the power plant steam and condensate loop. However, it will be appreciated that the cleaning fluid amount that is used will need to be made-up through the de-mineralized water make-up supply 30.

After the cleaning water is sprayed on to the tube panel bundles 20, which may be relatively dirty by the cleaning system 50. The dirty cleaning water is drained off and/or disposed of.

It will be appreciated that this system provides a method wherein a fraction of relatively warm condensate water can be drawn off of a power plant condensate loop, and the warm water can be used for cleaning of condensate tubes, either reducing or eliminating entirely a need for additional heaters to heat the cleaning fluid. This can provide for greater thermal efficiency of the overall system, as well as reducing extra structure. Moreover, even if a supplemental heater is employed for the cleaning fluid, the supplemental heater needs to impart less energy than it would otherwise. It has been found in some instances that cleaning with warm cleaning water, or even the cleaning water heated to the point of steam, can provide for a more effective cleaning than cleaning with cold water. Also, in installations where supplemental water (such as municipal, well or ground water) is not readily available, then the overall installation becomes more self-contained since the de-mineralized circuit water which is already present is used for cleaning.

Although the power plant/condenser loop is described by way of example above as using de-mineralized water, the system described herein is also applicable to power plant/condenser systems using plain water or water that has been treated in any fashion.

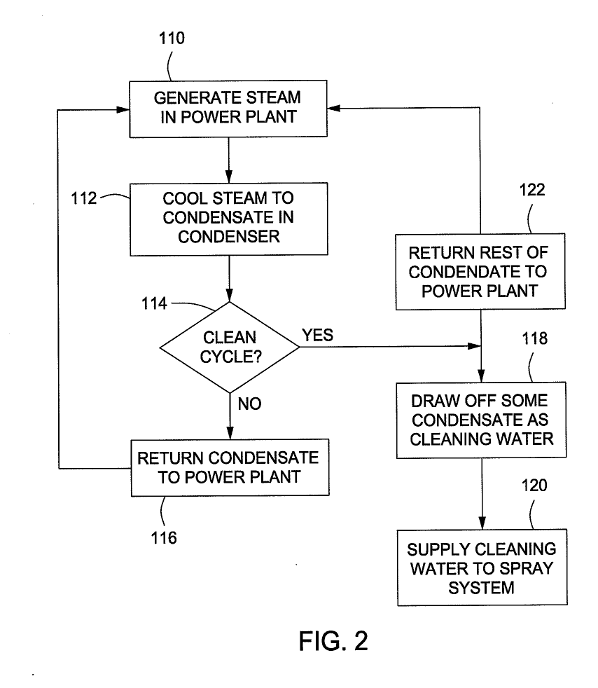

FIG. 2 is a process flow diagram illustrating a method according to the present invention. At step 110, steam is generated in a power plant. At step 112, steam is cooled to a condensate form in a condenser. At step 114, it is determined whether a cleaning cycle is being presently implemented. If a cleaning cycle is not being implemented, then at step 116 the condensate is returned to the power plant. However, if a cleaning cycle is being implemented at step 114, then at step 118 some condensate is drawn off to be used as cleaning water. At step 120 the drawn off condensate is supplied to a cleaning system such as a spray system. At the same time as the drawing off of condensate at step 118, the remaining condensate which is not being drawn off the condensate is returned to the power plant via step 122.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for cleaning components of an air-cooled condenser, comprising:
a spray cleaning system configured to spray cleaning fluid onto at least part of the air-cooled condenser; and
a line that draws off some condensate from the condenser that has been condensed by a condenser, and feeds the drawn-off condensate to the cleaning system for use as the cleaning fluid.

2. A system according to claim 1, further comprising a valve which controls the amount of condensate that is fed to the cleaning system.

3. The system according to claim 1, further comprising a cleaning fluid pump that pumps the drawn off condensate to the cleaning system.

4. The system according to claim 1, further comprising a supplemental heater that heats the drawn off condensate after it is drawn from the condensate line and before it enters the cleaning system.

5. The system according to claim 4, wherein the supplemental heater heats the drawn-off condensate to over 100° C.

6. The system according to claim 1, further comprising a supply of additional water for use as the cleaning fluid.

7. The system according to claim 1, wherein the condensate is de-mineralized water.

8. The system according to claim 1, wherein the cleaning system comprises spray nozzles.

9. A system for cleaning components of an air-cooled condenser, comprising:
means for spraying cleaning fluid onto at least part of the air-cooled condenser; and
means for diverting some off condensate from the condenser that has been condensed by a condenser, and feeding the drawn-off condensate to the cleaning system for use as the cleaning fluid.

10. A system according to claim 9, further comprising a valve means which controls the amount of condensate that is fed to the cleaning system.

11. The system according to claim 9, further comprising a cleaning fluid pumping means that pumps the drawn off condensate to the cleaning system.

12. The system according to claim 9, further comprising a supplemental heating means for heating the drawn-off condensate after it is drawn from the condensate line and before it enters the cleaning means.

13. The system according to claim 12, wherein the supplemental heating means heats the drawn-off condensate to over 100° C.

14. The system according to claim 9, further comprising means for supplying additional water for use as the cleaning fluid.

15. The system according to claim 9, wherein the condensate is de-mineralized water.

16. The system according to claim 9, wherein the spraying means comprises spray nozzles.

17. A power plant fluid handling system, comprising:
a power plant that produces steam;
an air-cooled condenser that receives the steam and provides a condensate;
a condensate holding tank that holds the condensate from the condenser;
a condensate pump that feeds condensate from the condensate holding tank back to the power plant; and
a spray cleaning system mounted to spray cleaning fluid onto the air-cooled condenser; and
a line that draws off condensate that has been condensed by a condenser from the air-cooled condenser and feeds the drawn off condensate to the cleaning system for use as the cleaning fluid.

18. A method for cleaning an air-cooled condenser, comprising:
means for generating steam in a power plant;
means for cooling the steam into a condensate using a condenser;
determining whether a cleaning cycle is to be performed:
means for returning the condensate to the power plant when a cleaning cycle is not to be performed; and
means for directing some condensate to be used as cleaning water and supplying the cleaning water to a cleaning system, and returning the remainder of the condensate to the power plant, when a cleaning cycle is to be performed.

19. A method for cleaning an air-cooled condenser, comprising:
generating steam in a power plant;
cooling the steam into a condensate using a condenser;
determining whether a cleaning cycle is to be performed:
when a cleaning cycle is not to be performed, returning the condensate to the power plant; and
when a cleaning cycle is to performed, drawing off some condensate to be used as cleaning fluid and supplying the cleaning fluid to a cleaning system, and returning the remainder of the condensate to the power plant.

20. The method according to claim 19, further comprising spraying the drawn-off condensate onto the condenser to clean the condenser.
